(19) United States
(12) Patent Application Publication
(10) Pub. No.: US 2025/0214334 A1
(43) Pub. Date: Jul. 3, 2025

(54) PRINTER AND PRINT POSITION ALIGNMENT METHOD

(71) Applicant: Roland DG Corporation, Hamamatsu-shi (JP)

(72) Inventors: Masayoshi KIMURA, Hamamatsu-shi (JP); Seiichi HIROOKA, Hamamatsu-shi (JP)

(21) Appl. No.: 19/003,005

(22) Filed: Dec. 27, 2024

(30) Foreign Application Priority Data
Dec. 28, 2023 (JP) 2023-222559

(51) Int. Cl. B41J 2/045

(52) U.S. Cl. CPC B41J 2/04505; B41J 2/04581

(57) ABSTRACT

A printer includes an ink head including nozzles aligned in a secondary scanning direction, a rotator to hold a second printed object and rotate the second printed object about an axis extending in a primary scanning direction, and a controller configured or programmed to control the ink head and the rotator and to include a nozzle usage range acquirer to acquire a nozzle usage range of nozzles of the plurality of nozzles that discharge ink, a first position acquirer to acquire a first position that is a desired print start position on an outer surface of the second printed object, and an aligner to rotate the second printed object to align the nozzle usage range and the first position so that the first position of the second printed object opposes the nozzles of the nozzle usage range.

### CROSS REFERENCE TO RELATED APPLICATIONS

This application claims priority based on Japanese Patent Application No. 2023-222559, filed on Dec. 28, 2023, the entire contents of which are incorporated herein by reference.

### BACKGROUND OF THE INVENTION

### 1. Field of the Invention

The present invention relates to printers and print position alignment methods.

### 2. Description of the Related Art

As disclosed in JP 2021-126855 A, printers have been known in the art that include an ink head and a rotator for rotating a printed object (the term “printed object” herein refers to an object on which printing is to be done). A plurality of nozzles are formed on the bottom surface of the ink head. The nozzles are ink discharge ports. The rotator rotates a three-dimensional printed object. By discharging ink from the ink head while rotating the printed object by the rotator, printing can be done on the outer surface of the printed object.

The printer disclosed in JP 2021-126855 A includes a light irradiation section that irradiates light toward the printed object. The light irradiation section irradiates light that serves as a mark for adjusting the rotational position of the printed object about the rotation axis. The user can use the light irradiated from the light irradiation section as a mark to accurately adjust the rotational position of the printed object about the rotation axis. Thus, it is easy for the user to desirably adjust the position to be printed first (hereinafter referred to as “print start position”) on the outer surface of the printed object.

Now, when printing on a printed object having a curved outer surface, such as a cylindrical printed object, nozzles to discharge ink may be limited to those within a predetermined range for the purpose of preventing the print quality from deteriorating. This is because the outer surface of the printed object is curved, and the distance between nozzles and the printed object varies depending on the position of nozzles. If the distance between a nozzle and the printed object is large, ink scatters and the print quality deteriorates. Therefore, by restricting the use of those nozzles with large distances, it is possible to prevent the print quality from deteriorating.

On the other hand, when the range of nozzles to be used (hereinafter referred to as the “nozzle usage range”) is changed as described above, the range of the printed object on which ink lands changes. Therefore, even if the rotational position of the printed object is exactly the same, the print start position will vary between when printing while limiting the nozzle usage range and when printing while not limiting the nozzle usage range. Therefore, when printing while limiting the nozzle usage range in order to prevent the print quality from deteriorating, printing may not be started from the print start position desired by the user, even if the rotational position of the printed object is adjusted accurately.

### SUMMARY OF THE INVENTION

Example embodiments of the present invention provide printers each capable of printing starting from a print start position desired by a user, while preventing print quality from deteriorating when printing on a three-dimensional printed object.

A printer according to an example embodiment of the present invention includes an ink head including a plurality of nozzles aligned in a first direction to discharge ink, a rotator to hold a printed object including an outer surface and rotate the printed object about an axis extending in a second direction orthogonal to the first direction, and a controller configured or programmed to control the ink head and the rotator, and to include a nozzle usage range acquirer to acquire a nozzle usage range of nozzles of the plurality of nozzles that discharge ink, a first position acquirer to acquire a first position that is a desired print start position on the outer surface of the printed object, and an aligner to rotate the printed object to align the nozzle usage range and the first position so that the first position of the printed object opposes the nozzles of the nozzle usage range.

With the configuration above, even if the nozzle usage range is limited in order to prevent the print quality from deteriorating, the aligner is configured or programmed to align the nozzle usage range and the first position. Thus, it is possible to perform printing starting from the print start position desired by the user while preventing the print quality from deteriorating.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a printer according to an example embodiment of the present invention.

FIG. 2 is a front view of the printer with the rotator removed.

FIG. 3 is a front view of the printer with the rotator installed.

FIG. 4 is a view of a carriage as viewed from below.

FIG. 5 is a perspective view of the rotator.

FIG. 6 is a schematic diagram of the carriage and the second printed object as viewed from the left side.

FIG. 7 is a block diagram of the printer.

FIG. 8 is a schematic diagram showing an example of the nozzle usage range, the first position and the second position.

FIG. 9 is a schematic diagram of the carriage and the second printed object, as viewed from the left side, where the first position and the second position coincide with each other.

FIG. 10 is a flow chart of a method of printing on the second printed object.

FIG. 11 is a schematic diagram of the second printed object, as viewed from the left side, when the first iteration of rotation operation is completed.

FIG. 12 is a schematic diagram of the second printed object, as viewed from the left side, when rotated to a position where the first position does not overlap with the nozzle usage range as viewed from above.

FIG. 13 is a schematic diagram of the second printed object, as viewed from the left side, when rotated to a position where the print end position overlaps with the nozzle usage range as viewed from above.

### DETAILED DESCRIPTION OF THE EXAMPLE EMBODIMENTS

Printers and methods of printing according to example embodiments of the present invention will now be described with reference to the drawings. Note that, the example embodiments described herein are not intended to limit the present invention in any particular way. The same or similar elements or functions are denoted by the same reference signs, and redundant explanations will be omitted or simplified as appropriate.

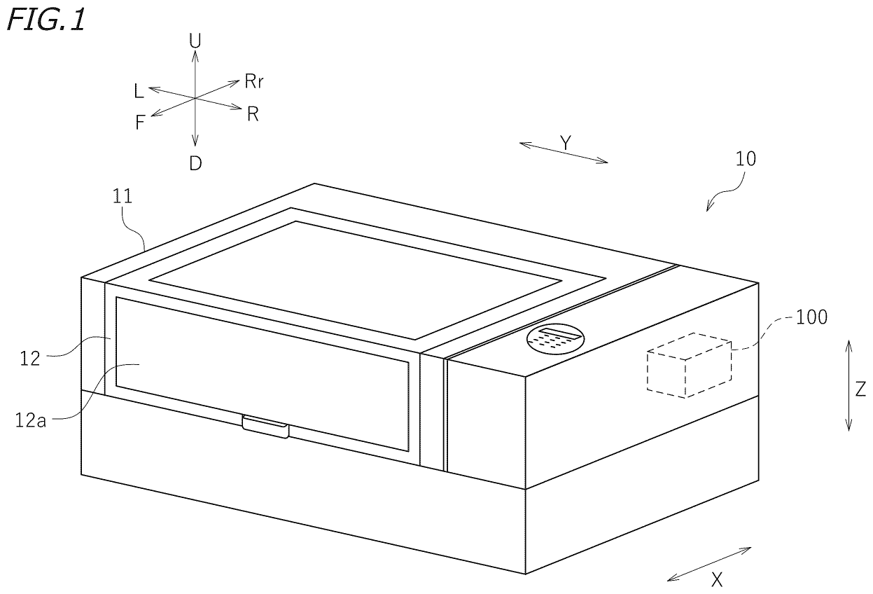

FIG. 1 is a perspective view of a printer 10 in the present example embodiment. The printer 10 in the present example embodiment is a flatbed-type printer. In the following description, for the purpose of discussion, the directions of the printer 10 are defined as follows. As the printer 10 is viewed from the front, the direction of moving away from the printer 10 is the forward direction, and the direction moving closer to the printer 10 is the rearward direction. Left, right, up and down as the printer 10 is viewed from the front are simply expressed as left, right, up and down. Reference signs F, Rr, L, R, U and D in the drawings refer to front, rear, left, right, up and down, respectively. Reference sign Y in the drawings denotes the primary scanning direction. The primary scanning direction Y is an example of the second direction. Reference sign X in the drawings denotes the secondary scanning direction. The secondary scanning direction X is an example of the first direction. Here, the primary scanning direction Y is the left-right direction, and the secondary scanning direction X is the front-rear direction. The primary scanning direction Y and the secondary scanning direction X are orthogonal to each other. Reference sign Z in the drawings denotes the up-down direction. The up-down direction Z is orthogonal to the primary scanning direction Y and the secondary scanning direction X. The directions defined above are only for the purpose of discussion, and do not limit how the printer 10 is installed, nor do they limit the scope of the present invention.

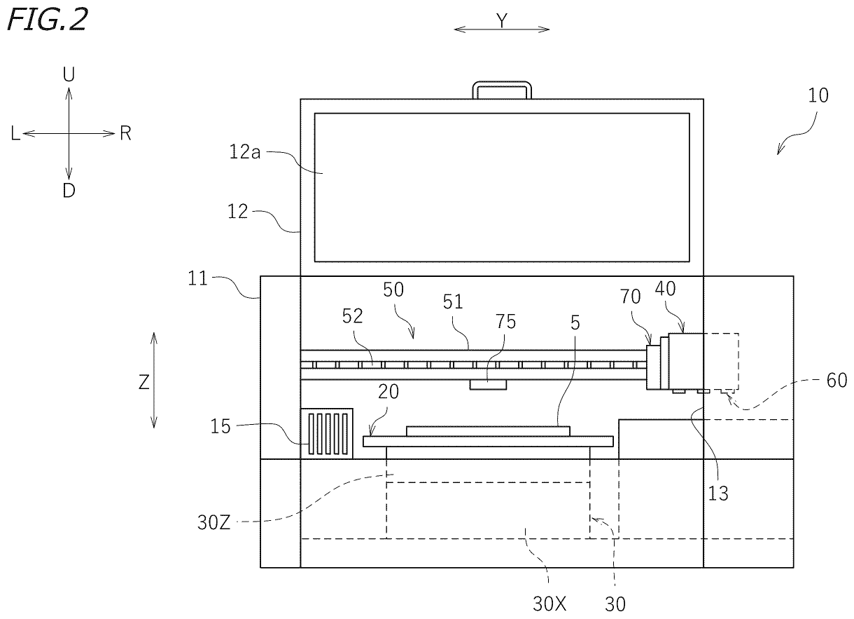

As shown in FIG. 2, the printer 10 can print on a first printed object 5 placed on a table 20 to be described below. The first printed object 5 at least partially includes a surface including a flat plane extending in the primary scanning direction Y and in the secondary scanning direction X. For example, the first printed object 5 is a recording paper, or the like. Note however that the first printed object 5 is not limited to a recording paper, but may be a sheet of a resin material, a metal plate, a glass plate, a wood plate, etc. The first printed object 5 may be a three-dimensional object such as a smartphone case.

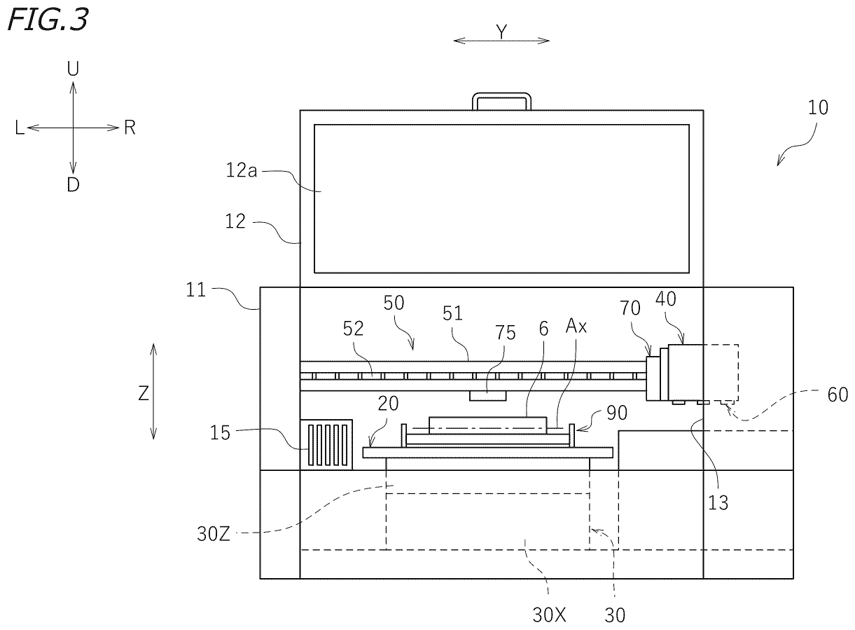

As shown in FIG. 3, the printer 10 can print on the outer surface of the second printed object 6 held by a rotator 90 to be described below. The second printed object 6 is a three-dimensional object, and the shape of the second printed object 6 may be a columnar shape, a cylindrical shape, etc. The second printed object 6 may include a surface including a curved plane or may include a surface including a plurality of intersecting flat planes. There is no particular limitation on the type of the second printed object 6, and it but may be a bottle or a cup, for example. In addition, there is no particular limitation on the material of the second printed object 6, and it may be glass, resin, wood, etc. The printer 10 prints on the outer surface of the second printed object 6 by alternately performing the rotation operation and the ink discharge operation. The rotation operation is an operation of rotating the second printed object 6 by the rotator 90 to be described later. The ink discharge operation is an operation of discharging ink from ink heads 60 to be described later.

As shown in FIG. 1, the printer 10 preferably has a box shape. The printer 10 includes a case 11 and a front cover 12. FIG. 2 and FIG. 3 are front views of the printer 10 with the front cover 12 open. As shown in FIG. 2 and FIG. 3, an opening 13 is formed in the front portion of the case 11. The front cover 12 is provided so that the opening 13 in the case 11 can be opened and closed. Here, the front cover 12 is supported by the case 11 so that the front cover 12 can rotate about an axis at its rear end. The front cover 12 includes a window portion 12a. The window portion 12a include a transparent acrylic plate, for example. The user can view the inside of the case 11 through the window portion 12a.

As shown in FIG. 2, the table 20, a table moving device 30, a carriage 40, a carriage moving device 50, a height detection device 75, and a controller 100 (see FIG. 1) are provided inside the printer 10.

The table 20 is a platform that supports the first printed object 5 and the second printed object 6. The table 20 is a flat plate-shaped structure and extends in the primary scanning direction Y and the secondary scanning direction X. The table 20 is arranged inside the case 11, generally at the center in the primary scanning direction Y.

The table moving device 30 is arranged downward of the table 20. The table moving device 30 moves the table 20 in the secondary scanning direction X and the up-down direction Z. The table 20 is supported from below by the table moving device 30. The table moving device 30 includes a secondary scanning direction moving device 30X and an up-down direction moving device 30Z. The up-down direction moving device 30Z supports the table 20 and moves it in the up-down direction Z. The secondary scanning direction moving device 30X supports the up-down direction moving device 30Z and moves it in the secondary scanning direction X. Note however that the configuration of the table moving device 30 is not limited to the configuration described above. For example, the positional relationship in the up-down direction between the secondary scanning direction moving device 30X and the up-down direction moving device 30Z may be reversed. The configuration of the secondary scanning direction moving device 30X and the up-down direction moving device 30Z is not limited, and any known moving mechanism may be used. As shown in FIG. 2, when printing on the first printed object 5, the printer 10 alternates between the operation of moving the table 20 forward and the operation of discharging ink while moving the carriage 40 in the primary scanning direction Y. Note however that the printer 10 may move the table 20 rearward instead of moving it forward.

The ink heads 60 and a pointer 70 are provided on the carriage 40. The ink heads 60 are located at the bottom of the carriage 40 and are opposing the table 20. In the present example embodiment, three ink heads 60 are provided. Note however that the number of ink heads 60 is not limited to this. The pointer 70 is arranged leftward of the ink heads 60. Note that the pointer 70 may be arranged rightward of the ink heads 60. The carriage 40 is arranged upward of the table 20 so as to oppose the table 20. The carriage 40 can be moved in the primary scanning direction Y by the carriage moving device 50.

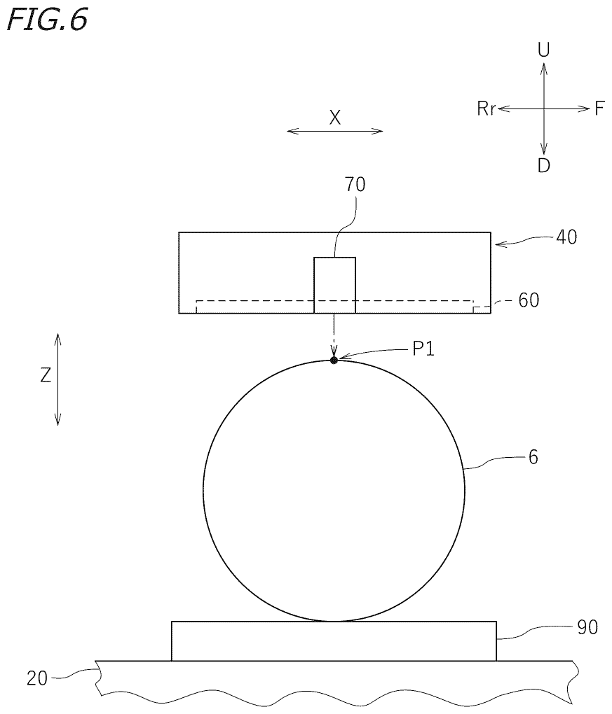

The carriage moving device 50 includes a guide rail 51, a belt 52, left and right pulleys (not shown), and a carriage motor 53 (see FIG. 6). As shown in FIG. 2, the guide rail 51 extends in the primary scanning direction Y. The carriage 40 is slidably engaged with the guide rail 51. An endless belt 52 is secured to the carriage 40. The belt 52 is wound around pulleys (not shown) provided on the right side and the left side of the guide rail 51. The carriage motor 53 is attached to one of the pulleys. The carriage motor 53 is a drive device that moves the carriage 40 along the guide rail 51. When the carriage motor 53 is driven, the pulleys rotate to drive the belt 52. Thus, the carriage 40 moves along the guide rail 51 in the primary scanning direction Y. Note however that the configuration of the carriage moving device 50 is not limited to this.

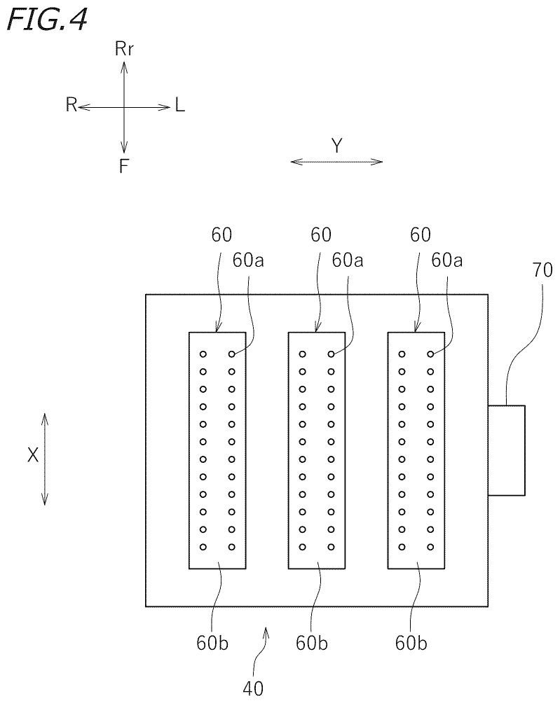

The ink heads 60 discharge ink toward the first printed object 5 or the second printed object 6 placed on the table 20. The ink heads 60 are connected to an ink cartridge 15 (see FIG. 2) housed in the case 11 by flexible ink tubes (not shown). As shown in FIG. 4, the ink heads 60 are aligned in the secondary scanning direction X.

As shown in FIG. 4, the ink heads 60 each have a nozzle surface 60b on which a plurality of nozzles 60a are provided. The nozzle surfaces 60b face downward and oppose the first printed object 5 or the second printed object 6 placed on the table 20. The nozzle surfaces 60b extend in the secondary scanning direction X. A plurality of nozzles 60a are aligned in the secondary scanning direction X to define a nozzle row. In FIG. 4, two nozzle rows are provided on one ink head 60. The nozzles 60a include microscopic holes through which ink is discharged. The nozzles 60a are each connected to a pressure chamber (not shown) in which ink is stored. Ink is discharged from the nozzle 60a as the pressure chamber expands or contracts by driving the piezoelectric element, for example. Note that twelve nozzles 60a are provided in one nozzle row in FIG. 4, but actually many more (e.g., 300) nozzles are formed. There is no limitation on the number of nozzles 60a provided in one nozzle row. There is no particular limitation on the number of nozzle rows.

The ink used in the present example embodiment is a photocurable ink that cures when irradiated with light. In the present example embodiment, the photocurable ink is a UV-curable ink that cures when irradiated with UV light. There is no particular limitation on the components and characteristics of the photocurable ink. There is no particular limitation on the color of the photocurable ink. Although not shown in the figures, the printer 10 may include a UV irradiation device that irradiates UV light to the first printed object 5 or the second printed object 6 placed on the table 20. This further promotes curing of the ink discharged from the ink head 60.

As described above, when printing on the outer surface of the second printed object 6, the rotator 90 is used to rotate the second printed object 6. As shown in FIG. 3, the rotator 90 is placed on the table 20 and is removable from the table 20. The rotator 90 rotates the second printed object 6 about the axis Ax extending in the primary scanning direction Y. In the present example embodiment, the rotator 90 rotates the second printed object 6 forward. Note that rotating the second printed object 6 forward includes rotating the second printed object 6 so that the highest portion of the second printed object 6 faces forward. Note however that the rotator 90 may also rotate the second printed object 6 rearward. As shown in FIG. 2, when printing on the first printed object 5, the rotator 90 is removed from the table 20.

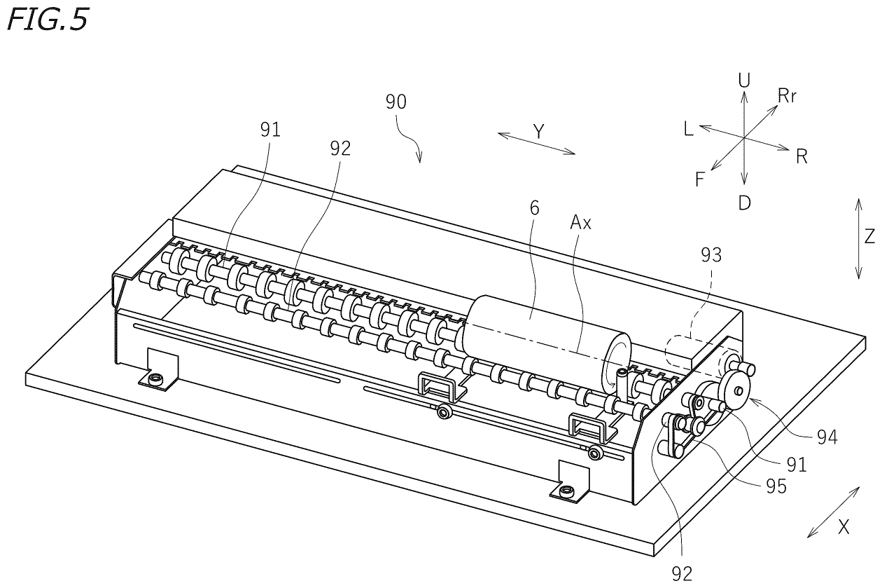

FIG. 5 is a perspective view of the rotator 90. The rotator 90 includes a first shaft 91, a second shaft 92, a rotation motor 93, a gear set 94, and a belt 95. The first shaft 91 extends in the primary scanning direction Y and can rotate about the axis Ax extending in the primary scanning direction Y. The first shaft 91 is connected to the rotation motor 93 via the gear set 94. The second shaft 92 is located forward relative to the first shaft 91. Similar to the first shaft 91, the second shaft 92 extends in the primary scanning direction Y and can rotate about an axis extending in the primary scanning direction Y. The belt 95 is wound around the first shaft 91 and the second shaft 92. When the rotation motor 93 is driven, the first shaft 91 rotates, and the second shaft 92 also rotates together with the first shaft 91 by the belt 95. The rotation motor 93 includes a built-in rotary encoder. Thus, it is possible to acquire the rotational position of the rotation motor 93. Note however that there is no particular limitation on the configuration of the rotator 90. The rotator 90 may include a mechanism usable to grip and rotate the second printed object 6.

The pointer 70 is a device that irradiates light as a marker for the user to desirably adjust the print start position to print on the second printed object 6. Here, the print start position is the portion of the outer surface of the second printed object 6 to which ink is first discharged. As shown in FIG. 6, the pointer 70 irradiates light onto the second printed object 6 placed on the rotator 90. In the present example embodiment, the pointer 70 is configured to irradiate light onto the highest portion of the second printed object 6. Note however that the location where the pointer 70 irradiates light is not limited to this. The pointer 70 includes an LED marker including an LED light source, for example. The user can adjust the rotational position of the second printed object 6 using the light irradiated from the pointer 70 as a mark. The user can specify the print start position by adjusting the rotational position of the second printed object 6 so that the light irradiated from the pointer 70 hits the print start position desired by the user.

The height detection device 75 is operable to measure the height of the second printed object 6 from the table 20. Here, the height of the second printed object 6 from the table 20 is the distance from the upper surface of the table 20 to the highest position of the second printed object 6. There is no particular limitation on the configuration of the height detection device 75, and any known device may be used. In the present example embodiment, the height detection device 75 is a contact-type height detection device. The height detection device 75 measures the height of the second printed object 6 from the table 20 by measuring the position of the table 20 in the up-down direction Z at the boundary between contact and non-contact of the second printed object 6 with the height detection device 75. The height detection device 75 may be a laser displacement meter or the like configured to measure the height of the second printed object 6 from the table 20 by irradiating a laser onto the second printed object 6.

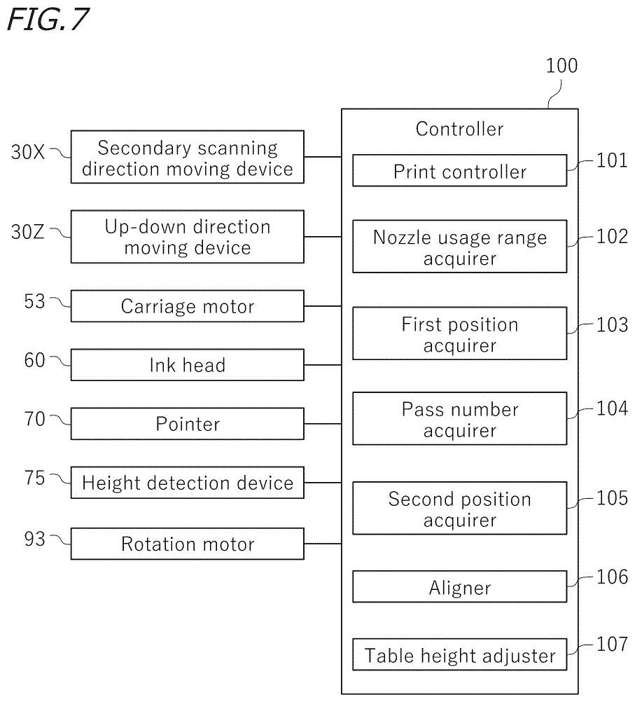

FIG. 7 is a block diagram of the example embodiment of the printer 10 according to the present example embodiment. The controller 100 is communicably connected to the secondary scanning direction moving device 30X, the up-down direction moving device 30Z, the carriage motor 53 of the carriage moving device 50, the ink head 60, the pointer 70, the height detection device 75, and the rotation motor 93 of the rotator 90, to control their operations. The controller 100 may be a microcomputer, or the like, including an interface (I/F), a CPU (Central Processing Unit), a ROM (Read Only Memory), a RAM (Random Access Memory), and a storage, for example. I/F receives print data, and the like, from external devices such as the host computer. The CPU executes instructions of the control program. The ROM stores the program to be executed by the CPU. The RAM is used as a working area for expanding the program. The storage stores the program and various data. In the present example embodiment, the controller 100 is provided inside the printer 10. Note however that the controller 100 does not necessarily need to be provided inside the printer 10. For example, the controller 100 may be a computer, or the like, installed outside of the printer 10 and connected to the printer 10 communicably via wired or wireless connection.

The controller 100 is configured or programmed to include a print controller 101, a nozzle usage range acquirer 102, a first position acquirer 103, the pass number acquirer 104, a second position acquirer 105, an aligner 106, and a table height adjuster 107. The controller 100 may be configured or programmed to include processing sections other than these, but their description and illustration are omitted here. These processing sections of the controller 100 are realized by a computer program or programs, for example.

The print controller 101 is configured or programmed to control the carriage moving device 50, the ink heads 60, and the rotator 90 to print on the outer surface of the second printed object 6. In the present example embodiment, the print controller 101 is configured or programmed to alternately execute the rotation control and the ink discharge control. The rotation control is a control to drive the rotator 90 to execute the rotation operation to rotate the second printed object 6 forward. The ink discharge control is a control to execute the ink discharge operation to discharge ink from the ink heads 60 while moving the carriage 40 in the primary scanning direction Y. In the first iteration of ink discharge control, the carriage 40 makes a round trip in the primary scanning direction Y. Note however that the carriage 40 may only make a one-way trip in one direction in the primary scanning direction Y, rather than making a round trip in the primary scanning direction Y, in one iteration of ink discharge control.

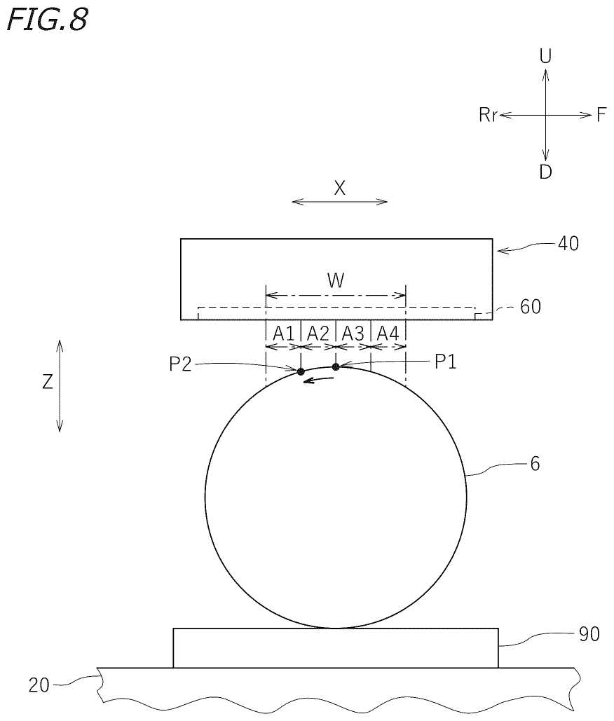

As shown in FIG. 8, the distance between the second printed object 6 and the bottom surface of the ink heads 60 varies depending on the position in the secondary scanning direction X. That is, the distance between the second printed object 6 and the nozzles 60a varies depending on the position in the secondary scanning direction X. When the distance between the second printed object 6 and the nozzles 60a increases, the accuracy of the landing of the photocurable ink discharged from the nozzles 60a decreases, thus deteriorating the print quality. Therefore, when printing on the second printed object 6, the present example embodiment limits the range of nozzles 60a from which to discharge the photocurable ink. In the following description, the range of nozzles 60a from which to discharge the photocurable ink will be referred to as the nozzle usage range w. The nozzle usage range acquirer 102 acquires the nozzle usage range W determined in accordance with the curvature of the surface of the second printed object 6 as viewed from the primary scanning direction Y. The nozzle usage range W is determined by an external computer connected to the printer 10, for example. The nozzle usage range W is determined by the external computer based on the shape and outer diameter information of the second printed object 6, and stored in the print data. In the present example embodiment, only nozzles 60a within the range where the distance between the nozzles 60a and the second printed object 6 is less than or equal to a predetermined value (e.g., 2 mm or less) are used, for example. The nozzle usage range acquirer 102 acquires information on the nozzle usage range W included in the print data. Note that the nozzle usage range W may be determined in the nozzle usage range acquirer 102. That is, the nozzle usage range acquirer 102 may determine the nozzle usage range W based on the shape and outer diameter information of the second printed object 6 that is input through the operation screen of the printer 10. FIG. 8 shows an example of the nozzle usage range W. Note that FIG. 8 does not show the pointer 70.

The first position acquirer 103 acquires, as the first position P1, the position on the surface of the second printed object 6 that is irradiated with the light of the pointer 70. In the present example embodiment, since the pointer 70 irradiates light onto the highest portion of the second printed object 6, the first position acquirer 103 acquires, as the first position P1, the position of the highest portion of the second printed object 6. The first position P1 is the print start position, as desired by the user, on the outer surface of the second printed object 6.

The pass number acquirer 104 acquires the pass number for printing. The pass number is the number of times the ink heads 60 move over a predetermined area within the print range while discharging ink in order to print on the predetermined area on the outer surface of the second printed object 6. Here, in the present example embodiment, the predetermined area is an area having a width, in the secondary scanning direction X, that is equal to the length of the nozzle usage range W in the secondary scanning direction X. In the present example embodiment, the carriage 40 moves in one direction in the primary scanning direction Y in one iteration of ink discharge control. While the present example embodiment is described assuming that the pass number is four, it is possible to set the pass number as desired by the user. Note that after the ink discharge is completed, the process may perform the operation in which the carriage 40 is moved in the primary scanning direction Y while the UV irradiation device is irradiating without discharging ink, to thereby cure the ink.

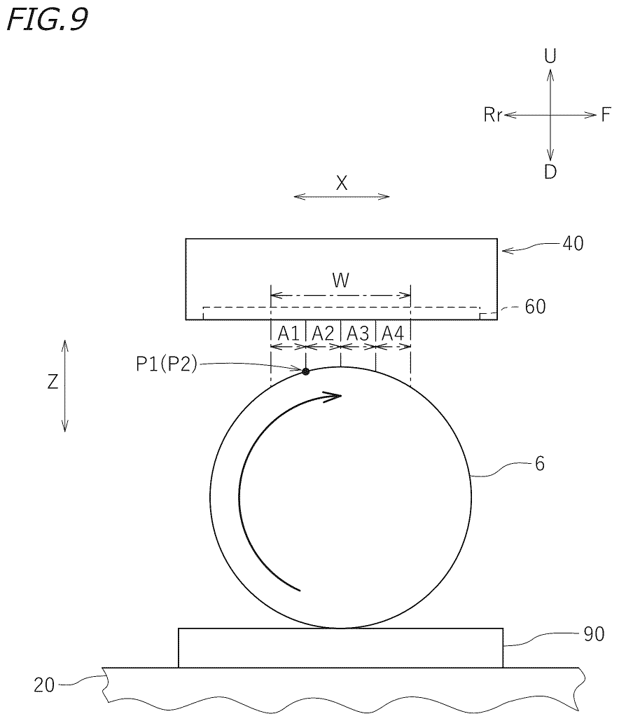

The second position acquirer 105 acquires the second position P2. Here, the second position P2 is the position at the rotationally downstream (i.e., downstream in the rotation direction of the second printed object 6) end of the most rotationally upstream (i.e., upstream in the rotation direction of the second printed object 6) one of the divided ranges obtained by dividing the nozzle usage range W based on the pass number. FIG. 8 shows an example of divided ranges and the second position P2 acquired by the second position acquirer 105. The ranges denoted by reference signs A1 to A4 in FIG. 8 are the divided ranges. In the present example embodiment, since the pass number for printing is set to four, there are four divided ranges A1 to A4. The divided ranges A1 to A4 are divided equally. As described above, when printing on the second printed object 6 in the present example embodiment, the second printed object 6 is rotated forward (see FIG. 9). Therefore, of the divided ranges A1 to A4 shown in FIG. 8, the most rotationally upstream one is the divided range A1, and the most rotationally downstream one is the divided range A4. The second position P2 in the present example embodiment is the position corresponding to the rotationally downstream end point of the most rotationally upstream divided range A1. Note that also in the figures other than FIG. 8, the dividing range are denoted by reference signs A1 to A4.

The aligner 106 is configured or programmed to be a processing section that rotates the second printed object 6 by the rotator 90 to align the nozzle usage range W and the first position P1 so that the first position P1 opposes the nozzles 60a in the nozzle usage range. In the present example embodiment, the aligner 106 rotates the second printed object 6 so that the first position P1 acquired by the first position acquirer 103 and the second position P2 acquired by the second position acquirer 105 are aligned with each other. Note that the aligner 106 may rotate the second printed object 6 forward or may rotate the second printed object 6 rearward. FIG. 9 is a schematic diagram of the second printed object 6 as viewed from the left side, when the first position P1 and the second position P2 are aligned with each other. Note that FIG. 9 does not show the pointer 70.

The table height adjuster 107 is configured or programmed to be a processing section that sets the position of the table 20 in the up-down direction Z for printing on the second printed object 6, and moves the table 20 to this position before ink is discharged onto the second printed object 6.

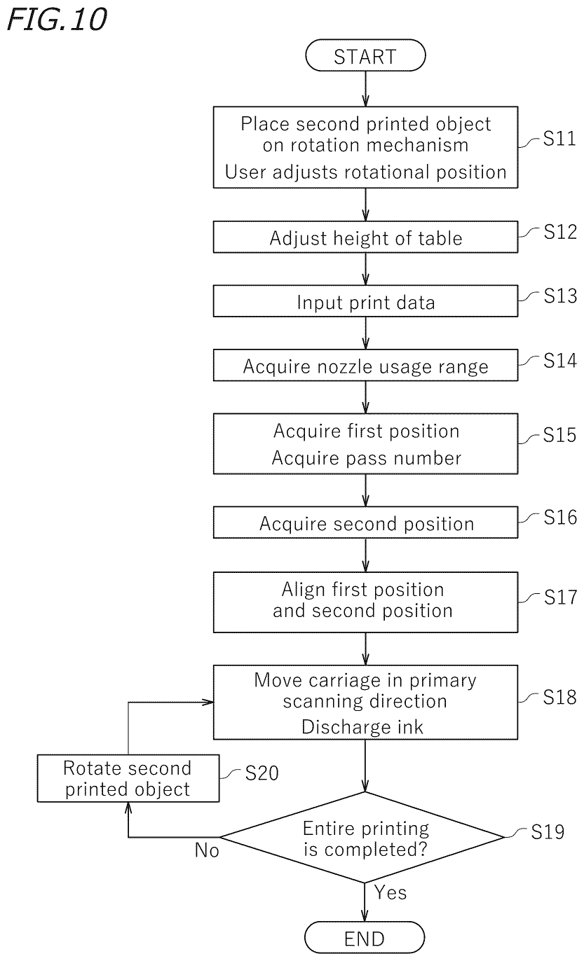

Next, the operation of the printer 10 when printing on the second printed object 6 will be described. FIG. 10 is an example of a flow chart when printing on the second printed object 6. From step S11 to step S17, the setup operation is performed. From step S18 to step S20, printing is performed on the second printed object 6.

In step S11, the user places the second printed object 6 on the rotator 90. At this time, the user places the second printed object 6 while adjusting the rotational position of the second printed object 6 so that the light of the pointer 70 hits the desired print start position.

After placing the second printed object 6, in step S12, the table height adjuster 107 adjusts the position of the table 20 in the up-down direction Z based on the height of the second printed object 6 from the table 20. In the present example embodiment, the height of the second printed object 6 from the table 20 is measured by the height detection device 75. Based on the measured height of the second printed object 6 from the table 20, the table height adjuster 107 adjusts the position of the table 20 in the up-down direction Z. Based on the height of the second printed object 6 from the table 20 measured by the height detection device 75 and the position of the ink heads 60 in the up-down direction Z, the table height adjuster 107 adjusts the position of the table 20 in the up-down direction Z so that the distance between the highest portion of the second printed object 6 and the ink heads 60 is a predetermined value (e.g., 1 mm), for example. Here, the position of the ink heads 60 in the up-down direction Z is known. Note that the table height adjuster 107 may adjust the height of the table 20 based on the height of the second printed object 6 that is input by the user without using the height detection device 75.

In step S13, the user inputs print data to the printer 10 from an external computer. In the present example embodiment, the print data is input to the controller 100. Here, the data to be input includes information such as the nozzle usage range W, the pass number for printing, image data for printing and the print range. Note however that the input print data is not limited to this, and may include data other than this. In step S14, the nozzle usage range acquirer 102 acquires the nozzle usage range W included in the print data.

In step S15, the first position acquirer 103 acquires the first position P1. As described above, in the present example embodiment, the first position acquirer 103 acquires, as the first position P1, the highest portion of the second printed object 6 irradiated with the light of the pointer 70. Similarly in step S15, the pass number acquirer 104 acquires the pass number for printing. In the present example embodiment, the pass number acquirer 104 acquires information on the pass number included in the print data.

In step S16, the second position acquirer 105 acquires the second position P2. As described above, in the present example embodiment, the second position acquirer 105 calculates the second position P2 by dividing the nozzle usage range W into a plurality of divided ranges A1 to A4 based on the pass number acquired in step S15. Here, the pass number is four, and therefore the nozzle usage range W is divided into four ranges. The second position acquirer 105 acquires, as the second position P2, the rotationally downstream end point of the most rotationally upstream divided range A1 out of the plurality of divided ranges A1 to A4. In step S17, the aligner 106 rotates the second printed object 6 so that the first position P1 is aligned with the second position P2.

After the setup operation described above is completed, the printer 10 prints on the second printed object 6. In step S18, the print controller 101 executes the ink discharge control. Therefore, in step S18, the printer 10 performs the ink discharge operation to discharge ink onto the second printed object 6 while moving the carriage 40 in the primary scanning direction Y. In the first iteration of step S18, the print controller 101 causes ink to be discharged from only nozzles 60a that are in the divided range A1. As a result, the print start position (the first position P1) specified by the user in step S11 is the rotationally downstream end point of the ink landing range. Therefore, printing can be performed starting from the print start position specified by the user.

After the first iteration of step S18 is completed, in step S19, the print controller 101 determines whether the entire printing has been completed. If the entire printing has not been completed and printing is also to be performed at other rotational positions (No in step S19), the process proceeds to step S20. If the print controller 101 determines that the entire ink discharge operation for the print range has not been completed, the process proceeds to step S20 (No in step S19).

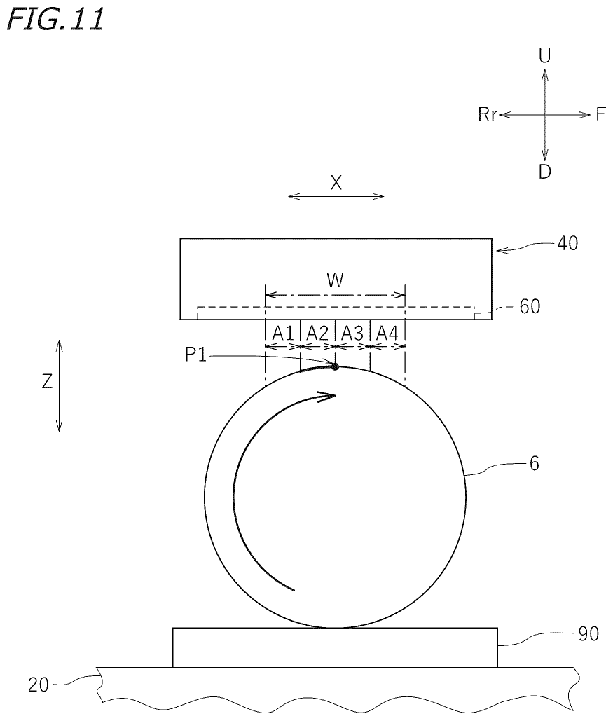

In step S20, the print controller 101 executes the rotation control. Therefore, the printer 10 performs the rotation operation to rotate the second printed object 6. Here, the amount of rotation of the second printed object 6 is calculated by the print controller 101 based on the nozzle usage range W acquired by the nozzle usage range acquirer in step S14 and the pass number acquired by the pass number acquirer 104 in step S15. In the present example embodiment, the second printed object 6 is rotated for the length of each divided range. Note that the amount of rotation may be corrected based on the outer diameter of the second printed object 6. As the second printed object 6 is rotated for the length of each divided range, the first position P1 moves forward to a position that coincides with the rotationally downstream end point of the divided range A2 as shown in FIG. 11. Note that the bold line section in FIG. 11 shows the range where ink has landed on the outer surface of the second printed object 6 at the time the first iteration of step S18 and step S20 is completed.

When step S20 is completed, the process returns to step

S18. In the second iteration of step S18, the print controller 101 executes the ink discharge control again. When the second iteration of step S18 is performed, the first position P1 coincides with the rotationally downstream end point of the divided range A2 as shown in FIG. 11. Therefore, in the second iteration of step S18, the print controller 101 causes ink to be discharged from nozzles 60a that are in the divided ranges A1 and A2, which are on the rotationally upstream side relative to the first position P1. Similarly, in the third iteration of step S18, since the first position P1 coincides with the rotationally downstream end point of the divided range A3, the print controller 101 causes ink to be discharged from nozzles 60a that are in the divided ranges A1, A2 and A3. When performing the fourth iteration of step S18, the first position P1 coincides with the rotationally downstream end point of the divided range A4, and the entire nozzle usage range W overlaps with the print range. Therefore, in the fourth iteration of step S18, the print controller 101 causes ink to be discharged from all nozzles 60a that are in the nozzle usage range W.

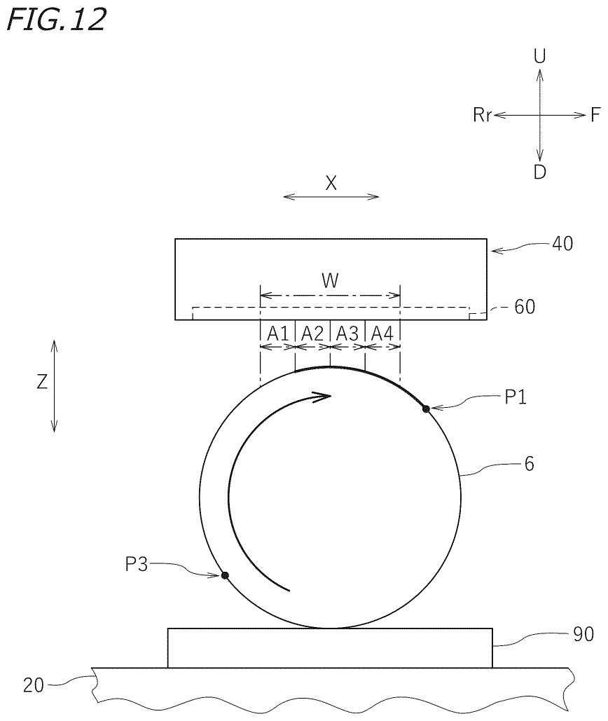

In the fifth and subsequent iterations of step S18, as shown in FIG. 12, the entire nozzle usage range W overlaps with the print range, so the print controller 101 causes ink to be discharged from all nozzles 60a that are in the nozzle usage range W. Note that the bold line section in FIG. 12 indicates the area of the outer surface of the second printed object 6 where ink has landed at the time the fourth iteration of step S18 and step S20 is completed. Reference sign P3 in FIG. 12 indicates the print end position. The print end position P3 is the opposite end of the print range from the print start position (i.e., the first position P1), for example.

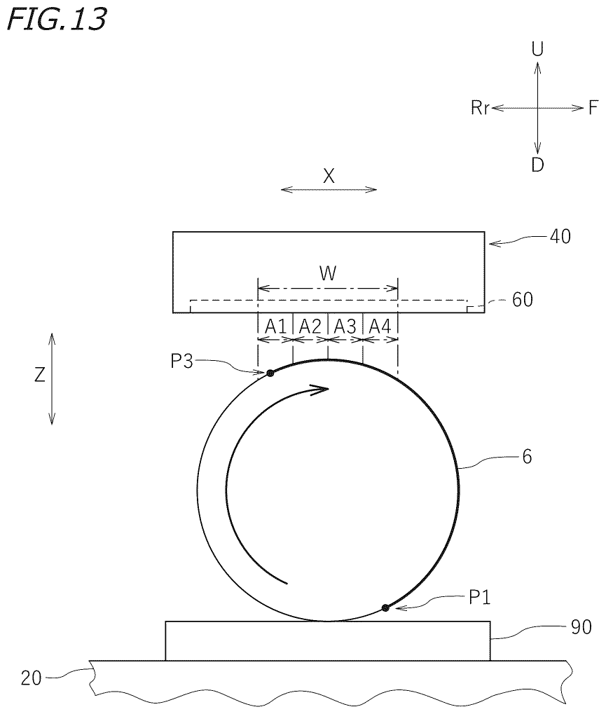

As shown in FIG. 13, when the print end position P3 of the print range reaches the position that overlaps with the nozzle usage range W as viewed from above, the print controller 101 causes ink to be discharged only from the nozzles 60a of the nozzle usage range W at the position that overlaps with the print range. In order to prevent ink from landing at positions outside the print range, the print controller 101 does not discharge ink from the nozzles 60a of the nozzle usage range W at positions that do not overlap with the print range. Note that the bold line section in FIG. 13 indicates the area on the outer surface of the second printed object 6 where ink has landed.

The printer 10 repeats the operation from step S18 to step S20 until the entire printing is completed. When the print controller 101 has printed all of the print data, the printer 10 ends the operation (Yes in step S19).

According to the present example embodiment, the printer 10 includes the ink head 60 including a plurality of nozzles 60a to discharge ink that are aligned in the secondary scanning direction X, the rotator 90 to hold the second printed object 6 and rotate the second printed object 6 about the axis Ax extending in the primary scanning direction Y, and the controller 100 configured or programmed to control the ink head 60 and the rotator 90. The controller 100 preferably is configured or programmed to include the nozzle usage range acquirer 102 to acquire the nozzle usage range, which is the range of nozzles 60a that discharge ink, the first position acquirer 103 to acquire the first position P1, which is the desired print start position on the outer surface of the second printed object 6, and the aligner 106 to align the nozzle usage range W and the first position P1 by rotating the second printed object 6 so that the first position P1 of the second printed object 6 opposes the nozzles 60a of the nozzle usage range W. Even if the nozzle usage range W is limited in order to prevent the print quality from deteriorating, the aligner 106 aligns the nozzle usage range W and the first position P1. Thus, it is possible to perform printing starting from the print start position desired by the user while preventing the print quality from deteriorating.

According to the present example embodiment, the nozzle usage range acquirer 102 acquires the nozzle usage range W based on the curvature of the outer surface of the second printed object 6. For example, the nozzle usage range acquirer 102 sets the nozzle usage range W to be smaller as the curvature of the outer surface of the second printed object 6 is larger, and sets the nozzle usage range W to be larger as the curvature of the outer surface of the second printed object 6 is smaller. By printing using only the nozzles 60a in a range that is suitable for the shape of the second printed object 6, it is possible to prevent the print quality from deteriorating.

According to the present example embodiment, the controller 100 preferably is configured or programmed to include the pass number acquirer 104 to acquire the pass number for printing, and the second position acquirer 105 to acquire the second position P2, which is the position at the rotationally downstream end of the most rotationally upstream one of the divided ranges obtained by dividing the nozzle usage range W based on the pass number. The aligner 106 rotates the second printed object 6 so that the first position P1 and the second position P2 coincide with each other. Thus, it is possible to align the nozzle usage range W and the first position P1 while taking into consideration the pass number for printing. Therefore, it is possible to print starting from the print start position desired by the user while preventing the print quality from deteriorating. Note that while the pass number is four in the present example embodiment, there is no particular limitation on the pass number. The pass number may be one, two, or three, and may be five or more, for example.

According to the present example embodiment, the printer 10 includes the pointer 70 that irradiates light toward the second printed object 6. The first position acquirer 103 acquires, as the first position P1, the position on the outer surface of the second printed object 6 that is irradiated with the light of the pointer 70. Thus, the user can easily set the print start position of the second printed object 6 using the light of the pointer 70 as a mark.

While some example embodiments of the present invention have been described above, the example embodiments described above are merely examples. Various other example embodiments are possible.

While the drive source of the rotator 90 is the rotation motor 93 in the example embodiments described above, the configuration of the rotator 90 is not limited to this. For example, the printer 10 may include a rack-and-pinion mechanism that can convert linear motion into rotational motion. The table 20 may be provided with a rack and the rotator 90 may be provided with a pinion so that the rotator 90 can convert a linear motion of the table 20 moving in the secondary scanning direction X into a rotational motion of the second printed object 6.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
an ink head including a plurality of nozzles aligned in a first direction to discharge ink;
a rotator to hold a printed object including an outer surface and rotate the printed object about an axis extending in a second direction orthogonal to the first direction; and
a controller configured or programmed to control the ink head and the rotator, and to include:
a nozzle usage range acquirer to acquire a nozzle usage range of nozzles of the plurality of nozzles that discharge ink;
a first position acquirer to acquire a first position that is a desired print start position on the outer surface of the printed object; and
an aligner to rotate the printed object to align the nozzle usage range and the first position so that the first position of the printed object opposes the nozzles of the nozzle usage range.

2. The printer according to claim 1, wherein the nozzle usage range acquirer is configured or programmed to acquire the nozzle usage range based on a curvature of the outer surface of the printed object.

3. The printer according to claim 1, further comprising a carriage to move the ink head in the second direction; wherein
the controller is configured or programmed to include:
a pass number acquirer to acquire a pass number, which is a number of times the ink head moves over a predetermined area of the outer surface of the printed object in the second direction in order to print on the predetermined area; and
a second position acquirer to acquire a second position, which is a position at a rotationally downstream end of a most rotationally upstream one of divided ranges obtained by dividing the nozzle usage range based on the pass number; and
the aligner is configured or programmed to rotate the printed object so that the first position and the second position coincide with each other.

4. The printer according to claim 1, further comprising a pointer to irradiate light toward the printed object; wherein
the first position acquirer is configured or programmed to acquire, as the first position, a position on the outer surface of the printed object that is irradiated with the light of the pointer.

5. A print position alignment method for a printer including an ink head with a plurality of nozzles aligned in a first direction to discharge ink, and a rotator to hold a printed object including an outer surface and to rotate the printed object about an axis extending in a second direction orthogonal to the first direction, the method comprising:
acquiring a nozzle usage range of nozzles of the plurality of nozzles that discharge ink;
acquiring a first position that is a desired print start position on the outer surface of the printed object; and
rotating the printed object to align the nozzle usage range and the first position so that the first position of the printed object opposes the nozzles of the nozzle usage range.
